(19) United States
(12) Patent Application Publication
(10) Pub. No.: US 2025/0031055 A1
(43) Pub. Date: Jan. 23, 2025

(54) Method and System for Network Location of Moving Mobile Base Stations Within a Network Topology

(71) Applicant: Telia Company AB, SOLNA (SE)

(72) Inventor: Timo Saija, Espoo (FI)

(73) Assignee: Telia Company AB, SOLNA (SE)

(21) Appl. No.: 18/714,208

(22) PCT Filed: Jan. 31, 2022
(86) PCT No.: PCT/SE2022/050102

§ 371 Date: May 29, 2024

Related U.S. Application Data
(60) Provisional application No. 63/284,101, filed on Nov. 30, 2021.

(51) Int. Cl. H04W 16/18; H04B 17/391; H04W 88/08

(52) U.S. Cl. CPC H04W 16/18; H04B 17/391; H04W 88/08

(57) ABSTRACT

The present disclosure relates to a method in a network topology including a plurality of mobile base stations (101-105), and to a system. The method comprising: determining (601) a cellular coverage function C(Cᵣ, . . . , C_{X},t,Mod,P,gE), of a moving mobile base station in a 3D time-dependent space S, wherein: Cᵣ, . . . , C_{X} denote the coverage of cells adjacent to the cell covered by the mobile base station; determining (602) a cellular area function A(Aᵣ, . . . , A_{X}, t), where the moving mobile base station has coordinates, and determining (603) a location of the moving mobile base station S*ᵢ(x₁, x₂, x₃, t) to be positioned.

### CROSS-REFERENCE TO RELATED APPLICATIONS

This application is a national stage application, filed under 35 U.S.C. § 371, of International Patent Application No. PCT/SE2022/050102 filed on Jan. 31, 2022, which claims the benefit of U.S. Provisional Patent Application No. 63/284,101 filed on Nov. 30, 2021, each of which are incorporated by reference herein in their entirety.

### TECHNICAL FIELD

The present disclosure relates generally to the field of data communications, and more particularly to a method, and a system for network location of moving mobile base stations within a network topology. The system involves network planning with moving mobile base stations.

### BACKGROUND

The evolution of current wireless access networks towards the fifth generation (5G), the sixth generation (6G) and beyond is characterized, among others, by the provisioning of high-bandwidth services and by the capability of serving traffic of a large network of user equipments. Provisioning high capacity in such networks requires network densification and smart network planning.

In traditional mobile telecommunications networks, mobile base stations are based on permanently fixed stationary towers and locations. The cellular coverage herein provided for each mobile network cell is planned based on the fixed topological structure.

Recently, the moving mobile base station concept has been introduced, in which the communication infrastructure on board vehicles act as a relay between user equipment(s) and static base stations. The choice of the relays instead of base stations simplifies the moving communication infrastructure and the network infrastructure, but it limits the possibility of dynamically adapting the moving infrastructure to changing conditions.

Mobile telecommunication networks based on moving mobile base stations and alternating network topology and structure confront the following challenges:
Alternating mobile network and cellular coverage that is non-optimized.
Mobile network topology derived from moving network elements that is non-optimized.
Geographical coordinates, i.e., locations of moving mobile base stations with regards of the Earth's surface, i.e., Riemannian/Euclidian two-dimensional manifold planes are not optimized.
Adjacent neighboring moving mobile base stations, the coverage areas of which are connected to a certain coverage area of the moving mobile base station for a certain particular coverage area considered. The cellular network planning is not optimized, and thus even redundant amount of overlapping become reality.

Further, a moving mobile telecommunications network core element such as a mobile base station moves along the three-dimensional geodesic surface space, and hence also Riemannian space in a time-dependent manner. A network management system shall facilitate that locations of moving mobile base stations are consequently positioned optimally with regards geographical coordinates and related two-dimensional manifold plane.

What is therefore needed is a system and method to address the aforementioned inadequacies.

### SUMMARY OF SOME EMBODIMENTS

It is an object of embodiments herein to provide a solution in terms of a method and a system for network location of moving mobile base stations within a network topology.

According to an aspect of some embodiments therein, there is provided a method in a network topology including a plurality of mobile base stations, wherein each mobile base station serves a cell, the method comprising: determining a cellular coverage function C(Cᵣ, . . . , Cₓ,t,Mod,P,gE), of a moving mobile base station in a three-dimensional time-dependent space, where: Cᵣ, . . . , Cₓ denote the coverage of cells adjacent to the cell covered by the mobile base station; t denotes time, Mod denotes a modulation applied by the moving mobile base station; P denotes a transmitter power of the mobile base station; and gE denotes a geographical elevation and geodesic, after moving from a location Si: (x₁, x₂, x₃, t)∈S, where x₁, x₂, x₃, denote coordinates with regards to the Earth and x₁, x₂ Earth's geographical coordinates; determining a cellular area function A(Aᵣ, . . . , Aₓ, t), where the moving mobile base station has coordinates Mᵢ: (x₁, x₂, h, t) in the Area A(Aᵣ, . . . , Aₓ, t) where Aᵣ, . . . , A denote the coverage of adjacent neighboring cells, x: s denote Euclidian locations at time t, and determining a location of the moving mobile base station S*ᵢ(x₁, x₂, x₃, t) to be positioned to the location satisfying at the time of t, the following:

$${{S}^{*}}_{i} ( {x}_{1} , {x}_{2} , {x}_{3} , t ) = max \{ C ( {C}_{r} , … , {C}_{x} , t , Mod , P , gE ) \} = max \{ \int \int \int S ( {x}_{1} , {x}_{2} , {x}_{3} , t ) {dx}_{1} {dx}_{2} {dx}_{3} \} ,$$

wherein S is the three-dimensional space wherein the moving mobile base station is located.

There is also provided a system in a network topology including a plurality of mobile base stations, wherein each mobile base station serves a cell, wherein the system is configured to: determine a cellular coverage function C(Cᵣ, . . . , Cₓ,t,Mod,P,gE), of a moving mobile base station in a three-dimensional time-dependent space, where: Cᵣ, . . . , C_{X} denote the coverage of cells adjacent to the cell covered by the mobile base station; t denotes time, Mod denotes a modulation applied by the moving mobile base station; P denotes a transmitter power of the mobile base station; and gE denotes a geographical elevation and geodesic, after moving from a location Si: (x₁, x₂, x₃, t)∈S, where x₁, x₂, x₃, denote coordinates with regards to the Earth and x₁, x₂ Earth's geographical coordinates; determine a cellular area function A(Aᵣ, . . . , Aₓ, t), where the moving mobile base station has coordinates Mᵢ: (x₁, x₂, h, t) in the Area A(Aᵣ, . . . , Aₓ, t) where Aᵣ, . . . , Aₓ denote the coverage of adjacent neighboring cells, x: s denote Euclidian locations at time t, and determine a location of the moving mobile base station S*ᵢ(x₁, x₂, x₃, t) to be positioned to the location satisfying at the time of t, the following:

$${{S}^{*}}_{i} ( {x}_{1} , {x}_{2} , {x}_{3} , t ) = max \{ C ( {C}_{r} , … , {C}_{x} , t , Mod , P , gE ) \} = max \{ \int \int \int S ( {x}_{1} , {x}_{2} , {x}_{3} , t ) {dx}_{1} {dx}_{2} {dx}_{3} \} ,$$

wherein S is the three-dimensional space wherein the moving mobile base station is located.

According to an embodiment, the cellular area network function is given by the following two-dimensional algebraic manifold, where the moving mobile base station is located:

$$A ( {A}_{r} , … , {A}_{x} , t ) = \int \int M ( {x}_{1} , {x}_{2} , h , t ) {dx}_{1} {dx}_{2} ,$$

and wherein on a boundary ∂M of such a two-dimensional algebraic manifold M, the signal strength of the moving mobile base station is reduced to be negligibly low, ∂M=0.

According to an embodiment, mapping, and projection between locations in a three-dimensional space and locations in a two-dimensional surface occur in both directions for determining locations and cellular coverage in a time-dependent manner.

According to an embodiment, the cellular coverage function C(Cᵣ, . . . , Cₓ,t,Mod,P,gE) is further a function of a smoothening factor θ and can be expressed as C(Cᵣ, . . . , Cₓ,t,Mod,P,gE,θ); and the cellular area function A(Aᵣ, . . . , Aₓ, t) is further a function of a smoothening factor ζ, and can be expressed as A(Aᵣ, . . . , Aₓ, t, ζ).

As an example, mappings and projections between real geodesic Riemannian three-dimensional space/sphere and two-dimensional manifold or surface occur in both directions to obtain (optimized) locations and cellular coverage, i.e., from three-dimensional real coordinates to two-dimensional manifold coordinates (geo-coordinates) in time-dependent manner.

According to an embodiment, the manifold or surface boundary ∂M shall be close to the boundaries of a real physical cell ∂S so that it coincides with cellular boundaries yield by modulation applied, signal strength dependent on the directed power and the boundary of adjacent cells so that the error and deviation functions remain close to zero (i.e., these functions shall be minimized).

According to another aspect of some embodiments therein, there is provided a system in a network topology including a plurality of mobile base stations, wherein each mobile base station serves a cell, the system comprising a computing device comprising a processor and a memory containing instructions executable by the processor whereby the computing device is configured to perform any of the subject-matter of the methods described herein or the subject-matter described with respect to the systems herein.

There is also provided a computer program comprising instructions which when executed by the processor of the computing device cause the processor to carry out the subject-matter of the methods described herein.

A carrier is also provided containing the computer program wherein the carrier is one of a computer readable storage medium, an electronic signal or a radio signal.

Additional embodiments of the present invention will be presented in the detailed description.

An advantage with embodiments herein is that mobile network and cellular coverage based on moving mobile base stations become optimized. Further geographical coordinates i.e. locations of moving mobile base stations with regard to the Earth's surface, i.e., Riemannian/Euclidian two-dimensional manifold become defined. The topology, cellular coverage and the structure of mobile network based on moving mobile base stations is also defined and optimized.

Another advantage of the embodiments herein is the support of the following practical solutions such as drone-based mobile base stations in, e.g., 5G networks, meshed network topologies, base stations ported to moving elements such as mobile devices (or user equipments) and minimized mobile base stations ported, tethered, and integrated in mobile devices. In addition, satellite based mobile telecommunications networks and base stations are supported.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a simplified illustration of a three-dimensional network structure in a three-dimensional geodesic Riemannian sphere on the Earth's surface;

FIG. 2 illustrates the mapping and projection of the three-dimensional network structure of FIG. 1 to a two-dimensional Riemannian manifold and plane;

FIG. 3 is a simplified meshed network architecture illustrating moving mobile base stations;

FIG. 4 illustrates the information that is shared between moving mobile base stations;

FIG. 5 is a generic illustration of a cellular coverage function that is three-dimensional, non-linear, and time-dependent around an optimal point of each mobile base station;

FIG. 6 depicts a flowchart of a method according to an embodiment herein; and

FIG. 7 illustrates a block diagram of a computing device, for a system, according to some embodiments herein.

### DETAILED DESCRIPTION

In the following, a detailed description of the exemplary embodiments is presented in conjunction with the drawings to enable easier understanding of the solutions(s) described herein.

It should be noted that the embodiments herein may be employed in any network topology or system involving any number mobile base station, such as drone-based mobile base stations, areal base stations, satellite-based base stations, wireless access points, femto base stations, relay base stations, vehicle-mounted base stations, unmanned arial vehicle-based base stations, etc. The base stations may be employed in a plurality of access network technologies such as in 5G networks, 6G networks, wireless sensor networks (WSN), WiFi networks, 3G networks, WiMax networks, or in hybrid or heterogeneous networks involving several radio access network technologies.

Mobile communications network coverage based on meshed cellular network with alternating and moving mobile base stations shall be aligned time-dependently with three-dimensional sphere and its two-dimensional manifold piece-wise projections with cellular boundaries to adjacent neighboring cells. A cell is a geographical area that is served by a base station. A manifold may be defined basically as a surface.

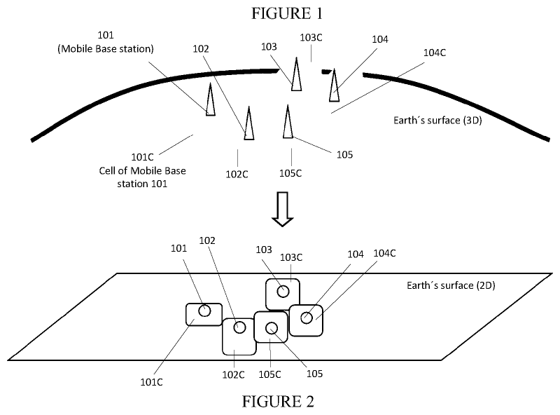

FIG. 1 is a simplified illustration of a three-dimensional network structure in a three-dimensional (3D) geodesic Riemannian sphere on the Earth's surface.

A network composed of five mobile base stations 101-105 is depicted. Each mobile base station has a respective coverage area or a cell 101C-105C. In the 3D network structure in the 3D geodesic Riemannian sphere on the Earth's surface, the position of the mobile base stations can be determined and can be (in reality) approximated in mathematical physics by a Euclidean 3D space and coordinates. A mapping and projection of the 3D geodesic Riemannian sphere including the 3D network into a 2D Riemannian manifold and plane is show in FIG. 2, in order to obtain the (optimized) geographical coordinates and to determine the cellular boundaries, latter being based on applied modulation, by each mobile base station, signalling power of each mobile base station, geographical elevation of each mobile base station as well as locations of adjacent neighboring mobile base stations. The mapped and projected manifold of the mobile cellular network of FIG. 1 into 2D geo-coordinates that also approximates adequately by a piece of the Earth's surface is depicted in FIG. 2.

Each mobile base station shall be located to a position where a non-linear 3D and time-dependent coverage function become optimized. The locations of mobile base stations shall hence be optimized also when the mobile communications network topology is based on time-dependently alternating meshed network topology and other neighboring mobile base stations move and roam also dynamically. The present disclosure hence solves the problem by providing optimized mobile base station location for a mobile network (e.g., a meshed network) based on moving mobile base stations and facilitates consequently optimal cellular coverage.

In addition, the best overall solution for the whole network topology with regards to positioning moving mobile base stations are calculated and assigned by applying mathematical game theory, both in cases of and following cooperative as well as non-cooperative game theories depending on the information availability of the neighboring cells and moving mobile base stations there.

Embodiments described herein solve the network optimization challenges that emerge with moving mobile base stations and dynamic network topologies by:
Aligning and combining the mathematical theory of Riemannian spaces and projections to optimized two-dimensional manifolds of minimum cellular and manifold overlapping with traditional mobile network and base station planning to determine cellular structure.
Providing mobile network and base station location topology for such a mobile communication network that acknowledges the moving mobile base stations and mesh network topology, where these moving mobile base stations are communicating and connected to each other (examples: mobile base stations integrated to drones, satellite-based communication network, etc.).
Providing either the optimal or the sub-optimal location for the moving mobile base stations with reference to the whole cellular network topology, based on the herein introduced cell coverage function that takes neighboring cells into consideration:
   Either within the sub-optimized location (often local cell optimum location) and noncooperative or partly cooperative game theory in the cases when information concerning the neighboring cell and moving mobile base stations is not or only partly available (i.e., Nash equilibrium solution).
   Or within the optimized location and cooperative game theory in the cases when the information concerning the neighboring cell and moving mobile base stations there is adequately available.
Facilitating network management application systems with abovementioned features.

It is noteworthy to understand that primary and necessary mathematical theories underlying the solution, such as Riemannian space, algebra and manifold are known per ser. However, the core essential of the present solution herein resides on integrating, combining, and applying these theories to mobile communications networks and (meshed) time-dependent topologies of such networks.

A proposed solution as described herein acknowledges that the mobile base station cell coverage calculation fundamentals regarding mathematics and physics applied for each particular and individual cell applies. These prevailing terms can be shortly characterized and referred to as follows:
Modulation functions, such as based on Orthogonal Frequency Division Multiplexing (OFDM) and/or any other modulation techniques (e.g., Wideband Code Division Multiple Access (WCDMA), Phase Shift Keying (PSK), Quadrature Amplitude Modulation (QAM), etc.) applicable within a cell is denoted Mod in this disclosure for a cellular coverage function C(·), as will be presented.
Frequency spectrums and multiplexing techniques applied within each cell.
Power transmitted from each mobile base station applied to each base station sector to provide adequate coverage and serve the users/subscribers. Each mobile base station emits a transmitting power denoted by P in this disclosure for a cellular coverage function C(.).
Network and cell performance metrics.
Traffic dynamics and needs derived from users/subscribers roaming in the cell.
Geographical elevations and geodesic on the Earth's three-dimensional surface within each cell denoted gE in this disclosure for a cellular coverage function C(·).

Primarily, the standard and currently applied calculations of the mobile base station capacities and coverage are derived from the fact that the mobile telecommunications network is being composed of fixed-point mobile base stations whose locations are defined by a stationary point process. The related processes and locations are nevertheless ergodic (i.e., dynamic) but only within a particular cell but stationary with regards to the whole network. This said principle satisfies adequately the stationary mobile base station networks.

According to embodiments herein, and as will be demonstrated, a core foundation of embodiments is that they extend the ergodic and stationary concept mathematically as indicated by a cell coverage function denoted C(Cᵣ, . . . , Cₓ,t,Mod,P,gE) with time-dependency and the cell coverages of adjacent neighboring cells due to the alternating network topology and the concept of moving mobile base stations.

Mathematically this principle as above can be characterized as applying a fixed-point theorem so that at a certain time t moving mobile base stations are temporarily located in a stationary manner so that standard ergodic and dynamic processes can be applied for a particular cell. However, a novel addition to this concept is that neighboring adjacent mobile base stations are also considered in the calculations. The solution can be described as a solution with several fixed points.

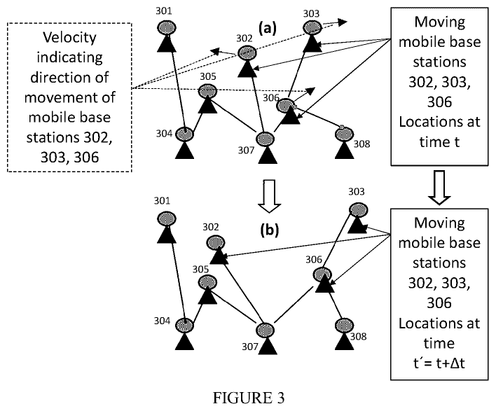

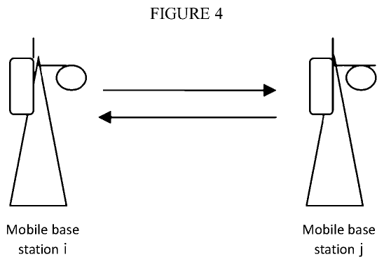

Referring to FIG. 3, an example of a meshed network topology and its moving mobile base stations is depicted. The network topology is shown comprising 8 mobile base stations 301-308. In topology (a), moving mobile base stations 302, 303 and 306 are shown at locations at time t before the movement. The velocity indicators of mobile base stations 302, 303 and 306 are depicted as arrows showing the direction of movement of the respective mobile base station. In topology (b), the locations of the moving mobile base stations 302, 303 and 306 at time t′=t+Δt are also depicted.

It should be noted that FIG. 3 only shows an example of three moving mobile base stations. Fewer or more mobile base stations may move simultaneously or at different times. The cell coverage of each mobile base station is not depicted.

As previously mentioned and according to an embodiment, a cell coverage function is determined or calculated for a moving mobile base station (and mobile network topology) in a three-dimensional time-dependent space to facilitate optimized cellular coverage function C(Cᵣ, . . . , Cₓ,t,Mod,P,gE), where Cᵣ, . . . , Cₓ denote the coverage of cells adjacent to the cell covered by the moving mobile base station, t denotes time, Mod denotes applied modulation, P the mobile base station transmitter power and gE the geographical elevation and geodesic after moving from a location Sᵢ: (x₁, x₂, x₃, t)∈S, where x₁, x₂, x₃, denote the coordinates with regards to the Earth and x₁, x₂ Earth's geographical coordinates. These coordinates provide in the use an approximation of the curved geodesic surface of the Earth.

For these definitions the following conditions apply:
The cellular coverage function equaling the volume integral over the three-dimensional space denoted S, where the moving mobile base station with cellular coverage is located, can hence be written as:

$$C ( {C}_{r} , … , {C}_{x} , t , Mod , P , gE ) = \int \int \int S ( {x}_{1} , {x}_{2} , {x}_{3} , t ) {dx}_{1} {dx}_{2} {dx}_{3} \qquad ( 1 )$$

The signalling strength depends on the mobile base station transmitter power P, and on the boundary of the defined three-dimensional space S denoted ∂S, the signalling strength reduces to be negligibly low, in practice without coverage, so we yield:

P=P(SignallingStrength)

∂S≈0 (meaning negligible or zero coverage on the boundary of a cell) that hence in practice equals SignallingStrength<N [dBm] (N being −110 dBm for example).

According to an embodiment, the cellular coverage function C(Cᵣ, . . . , C_{X},t,Mod,P,gE) is further a function of a smoothening factor θ and can be expressed as C(Cᵣ, . . . , C_{X},t,Mod,P,gE,θ).

The smoothening factor θ may be attached to or be viewed as a modelling and smoothening factor to the cellular coverage function C to handle non-analytic factors such as signal scattering, signal power, modulation, frequency spectrum and noise reduction in a manner to approximate the cellular coverage function adequately as an analytic and ergodic function with the volume integral over the three-dimensional space S.

According to an embodiment, a (mathematical) calculation is performed by applying two-dimensional time-dependent algebraic manifolds or surfaces of Mᵢ: (x₁, x₂, h, t)∈M and Mᵢ′: (x₁′, x₂′, h′, t′)∈M′ as optimized projections.

The moving mobile base station location can be determined to possess coordinates Mᵢ: (x₁, x₂, h, t) in an Area A(Aᵣ, . . . , Aₓ, t) where Aᵣ, . . . , Aₓ denote the coverage of adjacent neighboring cells, x: s denote Euclidian locations at the time t. Dependent on time, i.e., after the elapsed time of Δt a moving mobile base station roams to another location Mᵢ′: (x₁′, x₂′, h′, t′) and Area A′ (Aᵣ′, . . . , Aᵣ′, t′), where t′=t+Δt. For these definitions the following conditions apply accordingly:
The cellular area function A(.) equaling the area integral over the two-dimensional algebraic manifolds, where the moving mobile base station is located, can hence be written as:

$$A ( {A}_{r} , … , {A}_{x} , t ) = \int \int M ( {x}_{1} , {x}_{2} , h , t ) {dx}_{1} {dx}_{2} , \qquad ( 2 )$$

On the boundary of such a two-dimensional algebraic manifold or surface, denoted ∂M, the signalling strength reduces to be negligibly low, in practice without coverage, as also derived from and accordingly to the calculation for ∂S:

∂M≈0

(negligible or zero coverage on the boundary of a cell) that hence in practice equals SignallingStrength<N [dBm] (N being −110 dBm for example).

According to an embodiment, the cellular area function A(Aᵣ, . . . , Aₓ, t) is further a function of a smoothening factor ζ, and can be expressed as A(Aᵣ, . . . , Aₓ, t, ζ).

The smoothening factor ζ is attached or may be viewed as a modelling and smoothening factor to the area function to handle non-analytic factors affecting the area to approximate the area function adequately as an analytic and ergodic function with the integral over the two-dimensional algebraic manifold M.

The cellular area covered by S is defined as per function C(·). C(·) is further related to and dependent on signalling strength function, modulation, mobile base station power and geographical circumstances. C′(.) is the cellular coverage function at the time of t′(=t+Δt). The cellular area covered by manifold M is defined as per function A(·) presented above.

An optimized moving mobile base station location in the meshed network shall satisfy at each time of t, t′, . . . , the following mapping projection to a piecewise Riemannian two-dimensional manifold (i.e., meaning geographical latitudes and longitudes), where the third dimension x₃=h (e.g., height) remains fixed from the time t to t′(=t+Δt) to the prevailing location (reference: a fixed-point theorem applied). This means in particular to perform a mapping location-wise from Sᵢ: (x₁, x₂, x₃, t)→Mᵢ: (x₁, x₂, h, t) so that the said location Mᵢ: (x₁, x₂, h, t) that belongs to the Manifold M determines the optimal mobile base station location with reference to the related cell coverage. Cellular coverage is in both cases (S, C(.)) and (M, A(.)) assumed to reach the maximum sufficient level for the moving mobile base station location at Sᵢ: (x₁, x₂, x₃, t).

The boundary ∂M of the manifold M determines and is then either equal or close to the optimized cellular coverage C(.) and being then a projection from the boundary ∂S respectively. These boundaries ∂M and ∂S shall coincide then with the respective boundaries of neighboring cells and manifolds.

According to an embodiment, the location or optimal point for each moving mobile base station S*ᵢ(x₁, x₂, x₃, t) is determined to be positioned to the location that satisfies at the time of t:

$${{S}^{*}}_{i} ( {x}_{1} , {x}_{2} , {x}_{3} , t ) = max \{ C ( {C}_{r} , … , {C}_{x} , t , Mod , P , gE ) \} = max \{ \int \int \int S ( {x}_{1} , {x}_{2} , {x}_{3} , t ) {dx}_{1} {dx}_{2} {dx}_{3} \} \qquad ( 3 )$$

According to an embodiment, such an optimal location S*ᵢ(x₁, x₂, x₃, t) for a moving mobile base station may be reached where the gradient function (i.e., vector derivative) of the cellular coverage function as presented below, becomes zero in relation to the coordinates x₁, x₂ and x₃ under the assumption that the cellular coverage function is analytic (i.e., continuously differentiable), and given the transmitter power P* of the moving mobile base station the cellular coverage area becomes both sufficient with regards of neighboring cells and maximized:

$$∇ \{ C ( {C}_{r} , … , {C}_{x} , t , Mod , P , gE ) \} = ∇ \{ \int \int \int S ( {x}_{1} , {x}_{2} , {x}_{3} , t ) {dx}_{1} {dx}_{2} {dx}_{3} \} = 0 \qquad ( 4 )$$

$$where P ( SignallingStrength ) = {P}^{*} , ∇ denoting the gradient .$$

According to embodiments of the present disclosure, cases where the functions C(Cᵣ, . . . , Cx,t,Mod,P,gE), S(x₁, x₂, x₃, t), A(Aᵣ, . . . , Ax, t) and M(x₁, x₂, h, t) are not analytic or continuously differentiable should also be covered. They can well be piecewise analytic and/or differentiable when the theoretical intent as discussed can be applied. Alternatively, and especially, the functions S(x₁, x₂, x₃, t) and M(x₁, x₂, h, t) that determine the coverage space and the coverage area respectively, can factually be continuous and regularly behaving, then rather decreasing or stable depending on the distance from the optimal location point, but represented and approximately adequately by either fully or piecewise analytic or continuously differentiable function. As a summary these cases where these said and mentioned cases where functions are not everywhere analytic or continuously differentiable shall be covered within embodiments of the present disclosure.

As previously described the cellular coverage function C may be expressed as a function of a smoothening factor θ and can be expressed as C(Cᵣ, . . . , Cₓ,t,Mod,P,gE,θ); and the cellular area function A may be a function of a smoothening factor ζ, and can be expressed as A(Aᵣ, . . . , Aₓ, t, ζ). Hence, the equations presented in this disclosure are also applicable when the cellular coverage function is given by C(Cᵣ, . . . , Cₓ,t,Mod,P,gE,θ); and when the cellular area function is given by A(Aᵣ, . . . , Aₓ, t, ζ).

According to an embodiment, the error (E) or deviation function E in terms of coverage between the mapped locations in surface or Manifold M and the real locations S shall be close to zero, i.e., E=S−M≈0. Further, the deviations shall satisfy the following: x₁−x₁≈0, x₂−x₂≈0) and x₃≈h at the time t.

The above calculations determine hence the optimal locations Si: (x₁, x₂, x₃, t)∈S and Mᵢ: (x₁, x₂, h, t)∈M for a particular cell of the moving mobile base station.

With the information on the neighboring moving mobile base stations being available, the overall optimal locations with regard to the whole network and its topology can be reached. This situation is mathematically determined and corresponding the theory of cooperative games, i.e., coalitions formed by sharing information. The following conditions are then met:
Information about the neighboring cells, cell coverages and locations of neighboring moving mobile base stations are now available, i.e., Cᵣ, . . . , Cₓ are determined and shared.
For such a situation of a coalitional game, it is comprised of a finite set of all moving mobile base stations in the whole mobile network, the number of which moving mobile base stations being denoted N and a characteristic overall utility function denoted v. The overall utility function is related to the mobile cell coverage with the number of mobile device entities roaming and prevailing in the area (i.e., subscribers roaming in the area with regards of traditional definition) and the provided bandwidth and communication capacity. The utility function becomes optimized when its maximum achievable value is reached. A subset of this finite set includes neighboring moving mobile base stations, denoted as sN, through which the information about cells, cell coverages and locations of moving mobile base stations becomes available.
The cooperative payoff function related to the optimal locations of S*ᵢ(x1, x2, x3, t) that as previously defined maximizes the cellular coverage function C(Cᵣ, . . . , Cₓ,t,Mod,P,gE) for a particular cell and such a moving mobile base station exactly determines the total attainable overall optimal value in terms of cellular coverage in the mobile network, as follows:

$$\sum {{S}^{*} ( j )}_{i} \text{} ( {x}_{1} , {x}_{2} , {x}_{3} , t ) [ \text{} for all calculated {{S}^{*} ( j )}_{i} in the network , j \to N ] = v ( N ) \qquad ( 5 )$$

The payoff function in the cooperative setup, how it is defined to be understood herein, is related to “inceptive” to leave the current location. If the current location is the optimal location, then there does not exist any cooperative payoff increase for a moving mobile base station to leave the currently prevailing location to obtain a better overall location.

This means that the moving mobile base stations shall and can be positioned so that the whole mobile network setup becomes optimized.
The core solution of the overall utility function v(N) is the one for which no coalition provides a better value greater (i.e., locations for the network) than the sum of its moving mobile base station currently prevailing locations within Δt. Therefore, no moving mobile base station in the network has any “incentive” to leave the currently prevailing location and obtain so a better overall location for the whole network. In this context this assumption and principle of “no incentive to leave” means application of a fixed-point theorem for the time-period of Δt concerning moving mobile base stations targeting optimal solution with the optimal attainable utility value v(N). This can be expressed mathematically as follows:

$$Comp ( v ) = \{ {{S}^{*} ( j )}_{i} ∈ {ℜ}^{3} ( t ) : \sum {{S}^{*} ( j )}_{i} ( {x}_{1} , {x}_{2} , {x}_{3} , t ) = v ( N ) ; \\ \sum {{S}^{*} ( j )}_{i} ( {x}_{1} , {x}_{2} , {x}_{3} , t ) \geq v ( sN ) for all sN ⊆ N \} \qquad ( 6 )$$

Where N denotes the number of all the moving mobile base stations in the network and sN denotes a subset of the moving mobile base stations in the same network. R³(t) denotes a general time-dependent three-dimensional sphere/space on the Earth, as being applied in this disclosure.

It should be noted that if the information of the neighboring moving mobile base stations is not available or is only partly available, the overall optimal locations with regards of the whole network and its topology as defined earlier for v(N) cannot be reached. In such a case we land to local sub-optimized locations i.e., solutions, one example of such a solution being v(sN) instead of v(N).

Mathematically such a situation corresponds to a non-cooperative game and the best attainable solution is often also the one known as Nash equilibrium in which each involved party (e.g., each moving mobile base station) is assumed to know the equilibrium strategies of the other involved parties and no involved party has anything to gain by changing only their own strategy. The extend of deviation of such a non-cooperative locally (i.e., for each cell or set of cells) optimized solution v(sN) from the optimized solution v(N) as in the case of co-operative game discussed above, depends wholly on the amount of information regarding neighboring moving mobile base stations available and sharable at each time t for a particular moving mobile base station that belongs to a specific cell.

As previously described, information is exchanged or shared between mobile base stations in the network. FIG. 4 illustrates an example with two mobile base stations i and j which can be neighboring mobile base stations. The information that the mobile base stations can share may include: coverage data, location data, cell information, cell boundary information, movement information, time, transmitter power, etc. The information may take place between moving mobile base stations to inform and share location information and recent movement information. As mentioned above, if the information on neighboring moving mobile base stations is not adequately available to a certain moving mobile base station, the total solution is based local or sub-optimized position and in the best attainable solution Nash equilibrium of a non-cooperative game. On the other hand, if the information of neighboring moving mobile base stations becomes adequately available, the overall optimal locations with regards of the whole network can be reached, as previously described in conjunction with the presented embodiments.

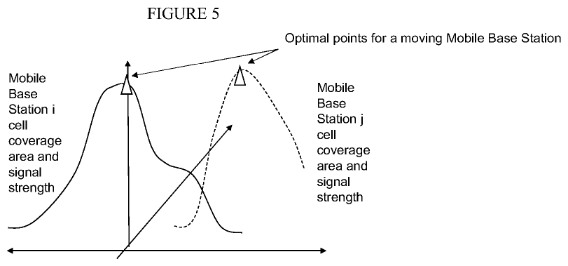

FIG. 5 is a generic illustration of a cellular coverage function that is three-dimensional, non-linear, and time-dependent around an optimal point of a mobile base station. Mobile base stations i and j cell coverage areas are depicted, as well as the optimal point of each mobile base station. It is assumed that the mobile base stations each has its own signalling strength for transmission/reception.

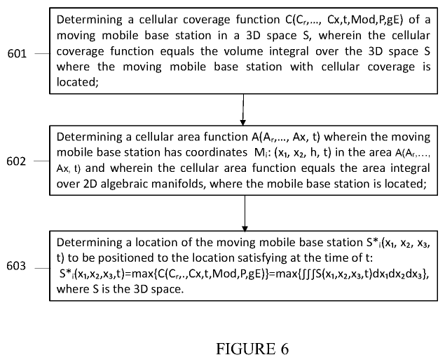

Referring to FIG. 6, there is illustrated a flowchart of a method according to some embodiments. The method comprising:
(601) Determining a cellular coverage function C(Cᵣ, . . . , Cₓ,t,Mod,P,gE) of a moving mobile base station in a three-dimensional space S, wherein the cellular coverage function equals the volume integral over the three-dimensional space S where the moving mobile base station with cellular coverage is located.

As previously described, Cᵣ, . . . , Cₓ denote the coverage area of cells adjacent to the moving mobile base station; t denotes time, Mod denotes applied modulation by the moving mobile base station, P denotes the moving mobile base station transmitter power and gE denotes the geographical elevation and geodesic after moving from location Si: (x₁, x₂, x₃, t)∈S, where x₁, x₂, x₃, denote coordinates with regards to the Earth and x₁, x₂ Earth's geographical coordinates. The cellular coverage function C(Cᵣ, . . . , Cₓ,t,Mod,P,gE) was previously presented in equation (1).

According to an embodiment, the signalling strength depends on the mobile base station transmitter power P and on the boundary ∂S of the defined three-dimensional space S.

As previously described, and according to an embodiment, the cellular coverage function C(Cᵣ, . . . , Cₓ,t,Mod,P,gE) is further a function of a smoothening factor θ and can be expressed as C(Cᵣ, . . . , Cₓ,t,Mod,P,gE,θ).
(602) Determining a cellular area function A(Aᵣ, . . . , Aₓ,t), wherein the moving mobile base station has coordinates Mᵢ: (x₁, x₂, h, t) in Area A(Aᵣ, . . . , Aₓ, t) where Aᵣ, . . . , Aₓ denote the coverage of adjacent neighboring cells, x: s denote Euclidian locations at the time t. Dependent on time, i.e. after the elapsed time of Δt a moving mobile base station roams to another location Mᵢ′: (x₁′, x₂′, h′, t′) in Area A′(Aᵣ′, . . . , Aₓ′, t′).

According to an embodiment, the cellular area function A(Aᵣ, . . . , Aₓ,t) equals the area integral over two-dimensional algebraic manifolds, where the moving mobile base station is located, as expressed in equation (2) previously presented.

As previously described, and according to an embodiment, the cellular area function A(Aᵣ, . . . , Aₓ, t) is further a function of a smoothening factor ζ, and can be expressed as A(Aᵣ, . . . , Aₓ, t, ζ).

According to an embodiment, a calculation is performed by applying two-dimensional time-dependent algebraic manifolds of Mᵢ: (x₁, x₂, h, t)∈M and Mᵢ′: (x₁′, x₂′, h′, t′)∈M′ as optimized projections.

According to an embodiment, on the boundary ∂M of such a two-dimensional manifold M, the signalling strength reduces to be negligibly low, in practice without coverage, as also derived from and accordingly to the calculation for ∂S.
(603) Determining a location of each moving mobile base station S*ᵢ(x₁, x₂, x₃, t) to be positioned to the location that satisfies at the time of t, the expression of equation (3), which is repeated below:

$${{S}^{*}}_{i} ( {x}_{1} , {x}_{2} , {x}_{3} , t ) = max \{ C ( {C}_{r} , … , {C}_{x} , t , Mod , P , gE ) \} = max \{ \int \int \int S ( {x}_{1} , {x}_{2} , {x}_{3} , t ) {dx}_{1} {dx}_{2} {dx}_{3} \} \qquad ( 3 )$$

According to an embodiment, such a location S*ᵢ(x₁, x₂, x₃, t) may be reached where the gradient function of the cellular coverage function C(Cᵣ, . . . , Cₓ,t,Mod,P,gE) becomes zero in relation to the coordinates x₁, x₂ and x₃ under the assumption that the cellular coverage function is analytic (i.e. continuously differentiable), and given the transmitter power P* of the moving mobile base station the cellular coverage area becomes both sufficient with regards of neighboring cells and maximized. The gradient of the cellular coverage function is expressed using equation (4), which is repeated below:

$$∇ \{ C ( {C}_{r} , … , {C}_{x} , t , Mod , P , gE ) \} = ∇ \{ \int \int \int S ( {x}_{1} , {x}_{2} , {x}_{3} , t ) {dx}_{1} {dx}_{2} {dx}_{3} \} = 0 \qquad ( 4 )$$

As previously described, embodiments of the present disclosure should however also cover the cases where the functions C(Cᵣ, . . . , Cx,t,Mod,P,gE), S(x₁, x₂, x₃, t), A(Aᵣ, . . . , Ax, t) and M(x₁, x₂, h, t) are not analytic or continuously differentiable. They can well be piecewise analytic and/or differentiable when the theoretical intent as discussed can be applied. Alternatively, and especially, the functions S(x₁, x₂, x₃, t) and M(x₁, x₂, h, t) that determine the coverage space and the coverage area respectively, can factually be continuous and regularly behaving, then rather decreasing or stable depending on the distance from the optimal location point, but represented and approximately adequately by either fully or piecewise analytic or continuously differentiable function. As a summary these cases where these said and mentioned cases where functions are not everywhere analytic or continuously differentiable shall be covered by embodiments of the present disclosure.

According to an embodiment, the Error E or deviation function in terms of coverage between the mapped locations in M and the real locations S shall be close to zero i.e. E=S−M≈0). The deviations shall satisfy following: x₁−x₁˜0, x₂−x₂≈0 and x₃≈h at the time t.

As previously described, the network is comprised of a finite set of all moving mobile base stations in the whole mobile network, the number of which moving mobile base stations being denoted N and a characteristic overall utility function denoted v. A subset of this set N includes neighboring moving mobile base stations, denoted as sN, through which the information about cells, cell coverages and locations of moving mobile base stations becomes available. The cooperative payoff function related to the optimal locations of S*ᵢ(x₁, x₂, x₃, t) that as previously defined maximizes the cellular coverage function C(Cᵣ, . . . , Cₓ,t,Mod,P,gE) for a particular cell and such a moving mobile base station exactly determines the total attainable overall optimal value in terms of cellular coverage in the mobile network as presented in equation (5), which is repeated below:

$$\sum {{S}^{*} ( j )}_{i} \text{} ( {x}_{1} , {x}_{2} , {x}_{3} , t ) [ \text{} for all calculated {{S}^{*} ( j )}_{i} in the network , j \to N ] = v ( N ) \qquad ( 5 )$$

This means that the moving mobile base stations shall and can be positioned so that the whole mobile network setup becomes optimized.

The solution of the overall utility function v(N) is the one for which no coalition provides a better value greater (i.e., locations for the network) than the sum of its moving mobile base station currently prevailing locations within Δt. Therefore, no moving mobile base station in the network has any “incentive” to leave the currently prevailing location and obtain so a better overall location for the whole network. In this context, this assumption and principle of “no incentive to leave” means application of a fixed-point theorem for the time-period of Δt concerning moving mobile base stations targeting optimal solution with the optimal attainable utility value v(N). This can be expressed mathematically as follows:

$$Comp ( v ) = \{ {{S}^{*} ( j )}_{i} ∈ {ℜ}^{3} ( t ) : \sum {{S}^{*} ( j )}_{i} ( {x}_{1} , {x}_{2} , {x}_{3} , t ) = v ( N ) ; \\ \sum {{S}^{*} ( j )}_{i} ( {x}_{1} , {x}_{2} , {x}_{3} , t ) \geq v ( sN ) for all sN ⊆ N \} \qquad ( 6 )$$

where N denotes the number of all the moving mobile base stations in the network and sN denotes a subset of the moving mobile base stations in the same network. R³(t) denotes a general time-dependent three-dimensional sphere/space on the Earth, as being applied in this disclosure.

Additional details of some embodiments have been presented.

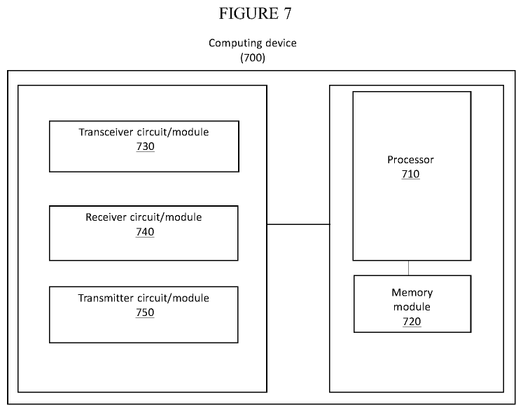

Another aspect of some embodiments relates to a system or in a computing device or a network node in a network topology including a plurality of mobile base stations, wherein each mobile base station serves a cell, the system comprising a computing device, as shown in FIG. 7, comprising a processor and a memory containing instructions executable by the processor whereby the computing device is configured to perform any of the subject-matter of methods described herein.

There is also provided a computer program comprising instructions which when executed by the processor of the computing device according to cause the processor to carry out the subject-matter of the methods described herein.

A carrier is also provided containing the computer program wherein the carrier is one of a computer readable storage medium, an electronic signal, or a radio signal.

A network management tool, such as Geographic Information System (GIS) applications may be used to implement some or all of the previously described embodiments.

FIG. 7 is a block diagram of an exemplary computing device 700 that may be incorporated into any of the components of the system in the present disclosure. In the system, the computing device 700 comprises processing circuitry or a processing module or a processor 710; a memory module 720; a receiver circuit or receiver module 740; a transmitter circuit or a transmitter module 750 and a transceiver circuit or a transceiver module 730 which may include transmitter circuit and receiver circuit. The processing circuitry 710 may include and/or be connected to and/or be configured for accessing (e.g., reading from and/or writing to) the memory module 720. The memory module 720 may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory).

The memory module 720 may be configured to store code executable by control circuitry and/or other data, e.g., data pertaining to communication, e.g., configuration and/or data of nodes, etc. The processing circuitry 710 may be configured to control any of the methods described herein and/or to cause such methods to be performed, e.g., by the processor 710. Corresponding instructions may be stored in the memory module 720, which may be readable and/or readably connected to the processing circuitry. In some examples, the processing circuitry 710 may include a controller, which may comprise a microprocessor and/or microcontroller and/or FPGA (Field-Programmable Gate Array) device and/or ASIC (Application Specific Integrated Circuit) device. It may be considered that the processing circuitry 710 includes or may be connected or connectable to the memory module 720, which may be configured to be accessible for reading and/or writing by the controller and/or processing circuitry 710. The computing device 700 may include additional components not depicted in FIG. 7.

According to some embodiments, the computing device 700 is configured or is operated to perform any one of the previously described embodiments.

Throughout this disclosure, the word “comprise” or “comprising” has been used in a non-limiting sense, i.e., meaning “consist at least of.” Although specific terms may be employed herein, they are used in a generic and descriptive sense only and not for purposes of limitation.

The present disclosure can be realized in hardware, software, or a combination of hardware and software. Any kind of computing system, or other apparatus adapted for carrying out the methods described herein, is suited to perform the functions described herein.

A typical combination of hardware and software could be a specialized computer system having one or more processing elements and a computer program stored on a storage medium that, when loaded and executed, controls the computer system such that it carries out the methods described herein. The present disclosure can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

It will be appreciated by persons skilled in the art that the embodiments of the invention or inventions described herein are not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention or inventions, which are limited only by the following claims.

1-18. (canceled)

19. A method performed by a computing device in a network topology including a plurality of mobile base stations, wherein each mobile base station serves a cell, the method comprising:
determining a mapping, between a three-dimensional time-dependent space S in which a moving mobile base station of the plurality of mobile base stations is located, and a two-dimensional time-dependent surface area M in which the moving mobile base station is located;
determining a cellular coverage function C of the moving mobile base station in the three-dimensional time-dependent space S, based at least on three-dimensional cellular coverages of cells adjacent to a cell covered by the moving mobile base station, a modulation type applied by the moving mobile base station, a transmitter power of the moving mobile base station, and a geographical elevation of the moving mobile base station;
determining a cellular area function A of the moving mobile base station in the two-dimensional time-dependent surface area M, based at least on two-dimensional cellular coverage areas of adjacent neighboring cells; and
determining a location of the moving mobile base station in the three-dimensional space S at a time of t based on a mapping between the cellular coverage function C and the cellular area function A, and wherein the cellular coverage function C is maximized.

20. The method according to claim 19, wherein a deviation function in terms of cellular coverage between locations in the surface area M and mapped locations in the three-dimensional space S is close or equal to zero.

21. The method according to claim 19, wherein the cellular coverage function C indicates a volume integral over the three-dimensional space S where the moving mobile base station with cellular coverage is located.

22. The method according to claim 19, wherein the cellular area function A is given by two-dimensional algebraic manifolds, where the moving mobile base station is located, and wherein the cellular area function A indicates an area integral over the two-dimensional manifolds corresponding to the two-dimensional time-dependent surface area M, and is given by:
$$A = \int \int M ( {x}_{1} , {x}_{2} , h , t ) {dx}_{1} {dx}_{2} ,$$
where x₁, x₂ are two-dimensional coordinates, h is a height value, and t indicates time.

23. The method according to claim 22, wherein, on a boundary ∂M of the two-dimensional algebraic manifold M, a signaling strength of the moving mobile base station is reduced to be negligibly low, ∂M≈0.

24. The method according to claim 19, wherein a signaling strength of the moving mobile base station depends on the transmitter power, and on a boundary of the three-dimensional space S, denoted ∂S, said signaling strength is reduced to be negligibly low, as ∂S≈0.

25. The method according to claim 19, wherein the location for the moving mobile base station, denoted as S*ᵢ(x₁, x₂, x₃, t), is reached when a gradient of the cellular coverage function C becomes zero in relation to the coordinates x₁, x₂, x₃.

26. The method according to claim 19, wherein a mapping and projection between locations in the three-dimensional space S and locations in the two-dimensional surface area M occur in both directions for determining locations and cellular coverage in a time-dependent manner.

27. The method according to claim 19, wherein the cellular coverage function C is further a function of a smoothening factor θ; and the cellular area function A is further a function of a smoothening factor ζ.

28. A system in a network topology including a plurality of mobile base stations, wherein each mobile base station serves a cell, the system comprising a computing device comprising a processor and a memory containing instructions executable by the processor whereby the computing device is configured to:
determine a mapping, between a three-dimensional time-dependent space S in which a moving mobile base station of the plurality of mobile base stations is located, and a two-dimensional time-dependent surface area M in which the moving mobile base station is located;
determine a cellular coverage function C of the moving mobile base station in the three-dimensional time-dependent space S, based at least on three-dimensional cellular coverages of cells adjacent to a cell covered by the moving mobile base station, a modulation type applied by the moving mobile base station, a transmitter power of the moving mobile base station, and a geographical elevation of the moving mobile base station;
determine a cellular area function A of the moving mobile base station in the two-dimensional time-dependent surface area M, based at least on two-dimensional cellular coverage areas of adjacent neighboring cells; and
determine a location of the moving mobile base station in the three-dimensional space S at a time of t based on a mapping between the cellular coverage function C and the cellular area function A, and wherein the cellular coverage function C is maximized.

29. The system according to claim 28, wherein a deviation function in terms of cellular coverage between locations in the surface area M and mapped locations in the three-dimensional space S is close or equal to zero.

30. The system according to claim 28, wherein the cellular coverage function C indicates a volume integral over the three-dimensional space S where the moving mobile base station with cellular coverage is located.

31. The system according to claim 28, wherein the cellular area function A is given by two-dimensional algebraic manifolds, where the moving mobile base station is located, and wherein the cellular area function A indicates an area integral over the two-dimensional manifolds corresponding to the two-dimensional time-dependent surface area M, and is given by:
$$A = \int \int M ( {x}_{1} , {x}_{2} , h , t ) {dx}_{1} {dx}_{2} ,$$
where x₁, x₂ are two-dimensional coordinates, h is a height value, and t indicates time.

32. The system according to claim 31, wherein, on a boundary ∂M of the two-dimensional algebraic manifold M, a signaling strength of the moving mobile base station is reduced to be negligibly low, ∂M≈0.

33. The system according to claim 28, wherein a signaling strength of the moving mobile base station depends on the transmitter power, and on a boundary of the three-dimensional space S, denoted ∂S, said signaling strength is reduced to be negligibly low, as ∂S≈0.

34. The system according to claim 28, wherein the location for the moving mobile base station, denoted as S*ᵢ(x₁, x₂, x₃, t), is reached when a gradient of the cellular coverage function C becomes zero in relation to the coordinates x₁, x₂, x₃.

35. The system according to claim 28, wherein a mapping and projection between locations in the three-dimensional space S and locations in the two-dimensional surface area M occur in both directions for determining locations and cellular coverage in a time-dependent manner.

36. The system according to claim 28, wherein the cellular coverage function C is further a function of a smoothening factor θ; and the cellular area function A is further a function of a smoothening factor ζ.
